(19) United States
(12) Patent Application Publication
(10) Pub. No.: US 2023/0049636 A1
(43) Pub. Date: Feb. 16, 2023

(54) TRAFFIC APPLICATION IF JUDGMENT APPARATUS, METHOD AND PROGRAM

(71) Applicant: Nippon Telegraph and Telephone Corporation, Tokyo (JP)

(72) Inventors: Mizuto NAKAMURA, Musashino-shi, Tokyo (JP); Toshihiko SEKI, Musashino-shi, Tokyo (JP); Naoyuki TANJI, Musashino-shi, Tokyo (JP)

(21) Appl. No.: 17/791,955

(22) PCT Filed: Jan. 22, 2020
(86) PCT No.: PCT/JP2020/002097

§ 371 Date: Jul. 11, 2022

(51) Int. Cl. H04L 47/24

(52) U.S. Cl. CPC H04L 47/24

(57) ABSTRACT

A traffic application IF determination device includes a setting unit 133 that performs processing of, in two different IFs, setting an IF connection relation between the two IFs to be high in a case where a difference between a difference value between a traffic amount received by one IF and a traffic amount transmitted by another IF and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in the same NW device, and a determination unit 134 that performs processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

### TECHNICAL FIELD

The present disclosure relates to a traffic application IF determination device, a traffic application IF determination method, and a traffic application IF determination program.

### BACKGROUND ART

Communication carriers operate and manage hundreds of thousands of networks (NWs), and when a failure occurs, it is necessary to quickly identify the location of the failure and ascertain its influence. All of this is implemented based on configuration information. When a service failure occurs, correct configuration information on the entire NW is required to quickly identify the location of the failure and ascertain the influence of the failure. However, at present, the configuration information is discretely managed by various management systems, and these management systems need to be linked to each other.

Consequently, PTL 1 discloses a topology estimation device that estimates an interface (IF) connection relation between NW devices. The topology estimation device compares the transmitted and received traffic amount of time-series data acquired from each IF of each NW device by taking a difference for each acquisition time (for example, 10:00, 10:15, . . . ) and estimates IFs having the smallest or matching differences as an IF connection relation.

For example, the topology estimation device acquires the transmitted traffic amount (in) and the received traffic amount (out) of each IF of each NW device from a traffic collection device, calculates {IFᵢ(t).in−IFⱼ(t),out} and {IFⱼ(t).in−IFᵢ(t).out} for two different IFs, IFᵢ and IFⱼ, and calculates a difference between two difference values. The topology estimation device performs the same calculation for all IFs between different NW devices and estimates IFs having the smallest difference as an IF connection relation. In a case where traffic data can be acquired, the IF connection relation can also be estimated between different layers.

The topology estimation device estimates the IF connection relation by comparing differences between traffic amounts, and thus can estimate the IF connection relation with a high level of accuracy between IFs in which traffic having a characteristic change over time is flowing. On the other hand, it is difficult to perform correct estimation in a case where there are a plurality of IFs in which little traffic having a change over time with similar features is flowing or in a case where there is an IF in which traffic having an almost constant value is flowing regardless of a time slot (for example, an IF of a backup NW device).

Consequently, NPL 1 proposes a method of improving the estimation accuracy of a topology estimation technique by imparting a feature amount by a traffic application device applying test traffic to each IF of each NW device. For example, in a NW device in which traffic having a constant value is flowing in each IF, different feature amounts are imparted by applying test traffic while shifting a timing.

### CITATION LIST

### Patent Literature

PTL 1: JP 5695767 B

### Non Patent Literature

NPL 1: Nakamura and four others, “Study on Investigation of Accuracy Improvement Methods in Configuration Management Technology using traffic information”, The Institute of Electronics, Information and Communication Engineers, IEICE Technical Report, 2019 General Conference, B-14-11, March 2019, p. 59-p. 64

### SUMMARY OF THE INVENTION

### Technical Problem

However, the traffic application device disclosed in NPL 1 merely imparts a feature by applying test traffic. On the other hand, because the amount of traffic that flows changes depending on the usage situation of a user in an actual NW, various situations such as whether there is a characteristic change in a time slot desired to be analyzed, whether the amount of traffic is constant, or whether it is not used can be assumed. Thus, there is a problem in that there are originally IFs to which test traffic does not need to be applied and it is not known to which IF the test traffic needs to be applied in the traffic application device.

The present disclosure was contrived in view of such circumstances, and an object of the present disclosure is to provide a technique capable of appropriately determining an IF to which test traffic is to be applied.

### Means for Solving the Problem

According to an aspect of the present disclosure, there is provided a traffic application IF determination device including a setting unit that performs processing of, in two IFs that are different, setting an IF connection relation between the two IFs to be high in a case where a difference between a difference value between a traffic amount received by one IF of the two IFs and a traffic amount transmitted by another IF of the two IFs and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in an identical NW device, and a determination unit that performs processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

According to an aspect of the present disclosure, there is provided a traffic application IF determination method that is performed by a traffic application IF determination device, the method including performing, by the traffic application IF determination device, processing of, in two IFs that are different, setting an IF connection relation between the two IFs to be high in a case where a difference between a difference value between a traffic amount received by one IF of the two IFs and a traffic amount transmitted by another IF of the two IFs and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in an identical NW device, and performing, by the traffic application IF determination device, processing of, in a predetermined IF, determining the predetermined IF to be an IF that is a target for traffic application in a case where the IF connection relation is set to be high with only a plurality of other IFs and determining the predetermined IF to he an IF that is a target for traffic non-application in a case where the connection relation is se to be high with one other IF for the plurality of IFs.

According to an aspect of the present disclosure, there is provided a traffic application IF determination program causing a computer to operate as the traffic application IF determination device.

### Effects of the Invention

According to the present disclosure, it is possible to provide a technique capable of appropriately determining an IF to which test traffic is to be applied.

### BRIEF DESCRIPTION OF DRAWINGS

FIG. 1 is a configuration diagram illustrating the entirety of a topology estimation system according to the present embodiment.

FIG. 2 is a block diagram illustrating a functional configuration of a traffic application IF determination device.

FIG. 3 is a flowchart illustrating an example of an operation of the traffic application IF determination device.

FIG. 4 is a diagram illustrating a setting example of a difference value calculation table.

FIG. 5 is a diagram illustrating a setting example of the difference value calculation table.

FIG. 6 is a diagram illustrating a setting example of the difference value calculation table.

FIG. 7 is a diagram illustrating an example of an application target determination table.

FIG. 8 is a diagram illustrating an example of the difference value calculation table in an LAG configuration.

FIG. 9 is a graph illustrating an example of time variation of a traffic amount of each IF in the LAG configuration.

FIG. 10 is a diagram illustrating an example of a method of narrowing down IFs that are targets for traffic application.

FIG. 11 is a block diagram illustrating a hardware configuration of the traffic application IF determination device.

### DESCRIPTION OF EMBODIMENTS

Hereinafter, an embodiment of the present disclosure will be described with reference to the accompanying drawings. In the description of the drawings, the same portions are denoted by the same reference numerals and signs, and the description thereof will be omitted.

### Summary of the Invention

In order to solve the above problem, the present disclosure discloses a traffic application IF determination device having a function of determining to which IF a test traffic needs to be applied. Specifically, for traffic data acquired by a traffic collection device from each NW device, a topology estimation device estimates an IF connection relation once. The traffic application IF determination device determines an IF that is a target for traffic application (a target for re-estimation) based on a difference in traffic amount between IFs calculated during the estimation of the IF connection relation and notifies a traffic application device of the determination result. Thereafter, the traffic application device applies the test traffic to an IF that is a target for traffic application which has been notified.

Topology Estimation System

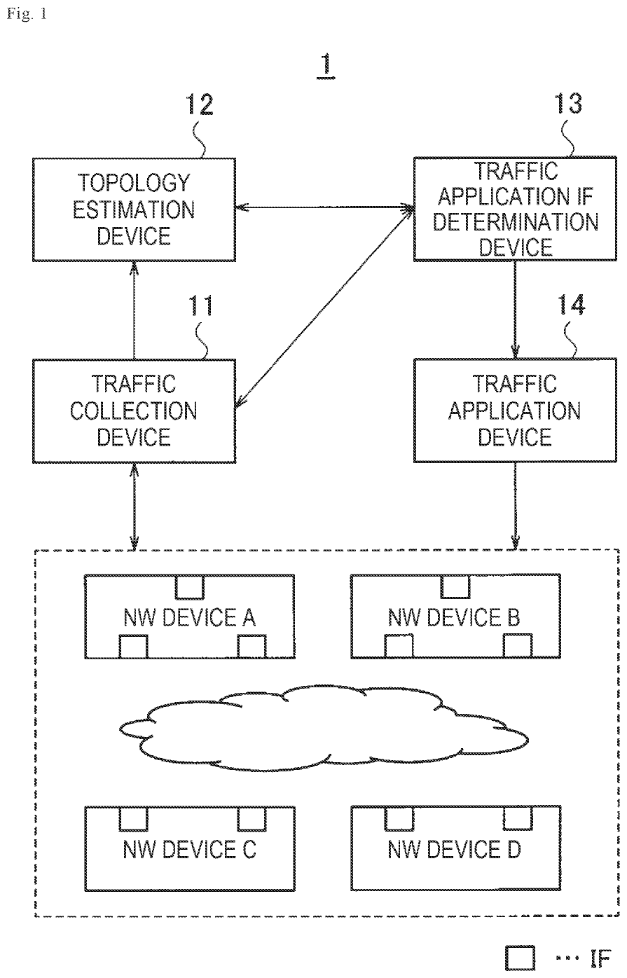

FIG. 1 is a configuration diagram illustrating the entirety of a topology estimation system 1 according to the present embodiment. The topology estimation system 1 includes a traffic collection device 11, a topology estimation device 12, a traffic application IF determination device 13, and a traffic application device 14.

The traffic collection device 11 is a device that collects traffic data (transmitted and received traffic amount) of each IF from each NW device that is a target for topology estimation.

The topology estimation device 12 is a device that compares the transmitted and received traffic amount of time-series data collected from each IF of each NW device by taking a difference for each acquisition time (for example, 10:00, 10:15, and estimates IFs having the smallest or matching differences as an IF connection relation. For example, the topology estimation device 12 acquires the transmitted traffic amount (in) and the received traffic amount (out) of each IF of each NW device from the traffic collection device 11, calculates {IFᵢ(t).in−IFⱼ(t).out} and {IFⱼ(t).in−IFᵢ(t).out} for two different IFs, IFᵢ and IFⱼ, and calculates a difference between two difference values. The topology estimation device 12 performs the same calculation for all IFs between different NW devices and estimates IFs having the smallest difference as an IF connection relation.

The traffic application IF determination device 13 is a device that determines an IF that is a target for traffic application (a target for re-estimation) based on a difference in traffic amount between the IFs calculated during the estimation of the IF connection relation performed by the topology estimation device 12 and notifies the traffic application device 14 of the determined IF that is a target for traffic application.

The traffic application device 14 is a device that imparts a feature amount by applying the test traffic to each IF of each NW device. In a case where the IF that is a target for traffic application is notified of by the traffic application IF determination device 13, the traffic application device 14 applies the test traffic only to the IF that is a target for traffic application which has been notified of. Thereby, the accuracy of estimation of the IF connection relation is improved.

Configuration of Traffic Application IF Determination Device

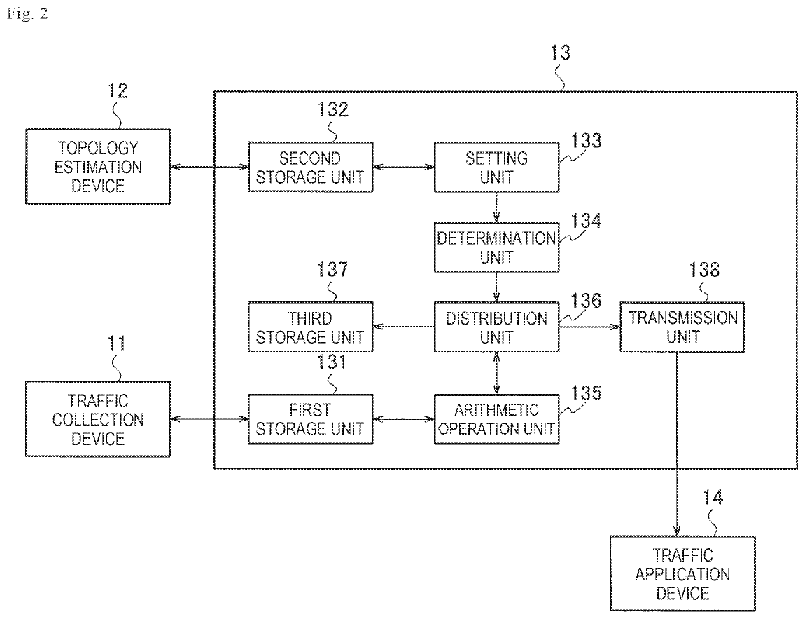

FIG. 2 is a block diagram illustrating a functional configuration of the traffic application IF determination device 13 according to the present embodiment. The traffic application IF determination device 13 includes a first storage unit 131, a second storage unit 132, a setting unit 133, a determination unit 134, an arithmetic operation unit 135, a distribution unit 136, a third storage unit 137, and a transmission unit 138.

The first storage unit 131 has a function of storing traffic data (a transmitted and received traffic amount) of each IF of each NW device that is a target for topology estimation which is acquired by the traffic application IF determination device 13 from the traffic collection device 11.

The second storage unit 132 has a function of storing data of the difference in traffic amount between the IFs calculated during the estimation of the IF connection relation which is acquired by the traffic application IF determination device 13 from the topology estimation device 12.

The setting unit 133 has a function of setting the IF connection relation between two different IFs to be high or low for each IF of each NW device based on the difference in traffic amount between the IFs which is read out from the second storage unit 132. Specifically, the setting unit 133 performs processing of, in two different Ifs, IFᵢ and IFⱼ, setting the IF connection relation between the two IFs to be “high” in a case where a difference between a difference value between a traffic amount received by one IFᵢ and a traffic amount transmitted by the other IFⱼ (={IFᵢ(t).in−IFⱼ(t).out}) and a difference value between a traffic amount received by the other IFⱼ and a traffic amount transmitted by the one IFᵢ (={IFⱼ(t).in−IFᵢ(t).out}) is small, and setting the IF connection relation between the two IFs to be “low” in a case where the difference is large. In addition, the setting unit 133 performs the processing for a plurality of IFs included in a plurality of different NW devices, excluding between a plurality of IFs included in the same NW device.

The determination unit 134 has a function of determining an IF that is a target for traffic application to which the test traffic is to be applied using the setting result of the IF connection relation in each IF of each NW device. Specifically, the determination unit 134 performs processing of, in a predetermined IF, determining the predetermined IF to be an IF that is a target for traffic application in a case where the IF connection relation is set to be “high” with a plurality of other IFs, and determining the predetermined IF to be an IF that is a target for traffic non-application in a case where the IF connection relation is set to be “high” with only one other IF. In addition, the determination unit 134 performs the processing for the plurality of IFs described above.

The arithmetic operation unit 135 has a function of narrowing down IFs that are targets for traffic application determined by the determination unit 134. Normally, in a case where a load balances is interposed between two NW devices or in a case where a link aggregation (LAG) configuration is constituted of two NW devices, the values of traffic amounts acquired by a plurality of IFs are likely to be close to each other, and then all differences between one IF in one NW device and multiple IFs in the other NW devices are small, and all IF connection relations are set to be “high”. In this case, in the determination unit 134, the one IF is determined to be an IF that is a target for traffic application.

However, for each IF having a load balancer or an LAG configuration, the average traffic amount is approximately constant for each IF, but the time variation of the traffic amount differs for each IF, and thus each IF can be sufficiently identified by taking a difference value of traffic data between the IFs at each time. That is, such an IF can be estimated with sufficient accuracy even though the traffic data before the application of the test traffic is used, and thus does not necessarily need to be included in an IF that is a target for traffic application. Consequently, in a case where the time variation of the traffic amount exceeds a threshold in an IF that is a target for traffic application determined by the determination unit 134, the arithmetic operation unit 135 excludes the IF that is a target for traffic application from IFs that are targets for traffic application.

The distribution unit 136 has a function of distributing an IF that is a target for traffic application determined by the determination unit 134 or an IF that is a target for traffic application narrowed down by the arithmetic operation unit 135, among IFs of each NW device that is a target for topology estimation, to an IF that is a target for traffic application to which the test traffic is to be applied.

The third storage unit 137 has a function of storing IF information of an IF distributed to the IF that is a target for traffic application to which the test traffic is to be applied.

The transmission unit 138 has a function of transmitting the IF information of the IF distributed to the IF that is a target for traffic application, to which the test traffic is to be applied, to the traffic application device 14.

Operation of Traffic Application IF Determination Device

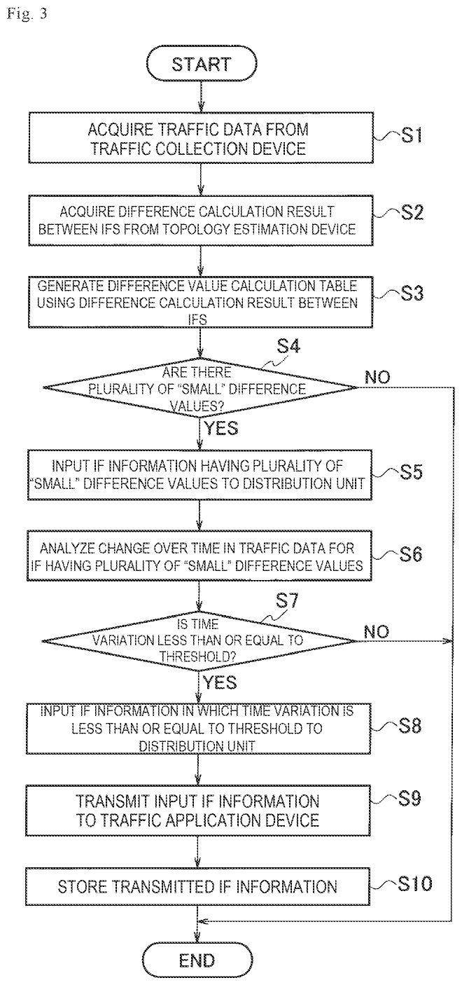

FIG. 3 is a flowchart illustrating an example of an operation of the traffic application IF determination device 13.

Step S1;

First, the first storage unit 131 stores traffic data (a transmitted and received traffic amount) of each IF of each NW device that is a target for topology estimation which is acquired by the traffic application IF determination device 13 from the traffic collection device 11.

Step S2;

Next, the second storage unit 132 stores data of the difference in traffic amount between the IFs calculated during the estimation of the IF connection relation which is acquired by the traffic application IF determination device 13 from the topology estimation device 12.

Step S3;

Next, the setting unit 133 sets the IF connection relation between two different IFs to be high or low for each IF of each NW device based on the difference in traffic amount between the IFs which is read out from the second storage unit 132. Hereinafter, a specific example of a setting method will be described.

First, for two different IFs, IFᵢ and IFⱼ, the setting unit 133 obtains a difference between a difference value between a traffic amount received by one IFᵢ and a traffic amount transmitted by the other IFⱼ and a difference value between a traffic amount received by the other IFⱼ and a traffic amount transmitted by the one IFᵢ, and sets a “large” and “small” of the difference in a difference value calculation table (step S3-1).

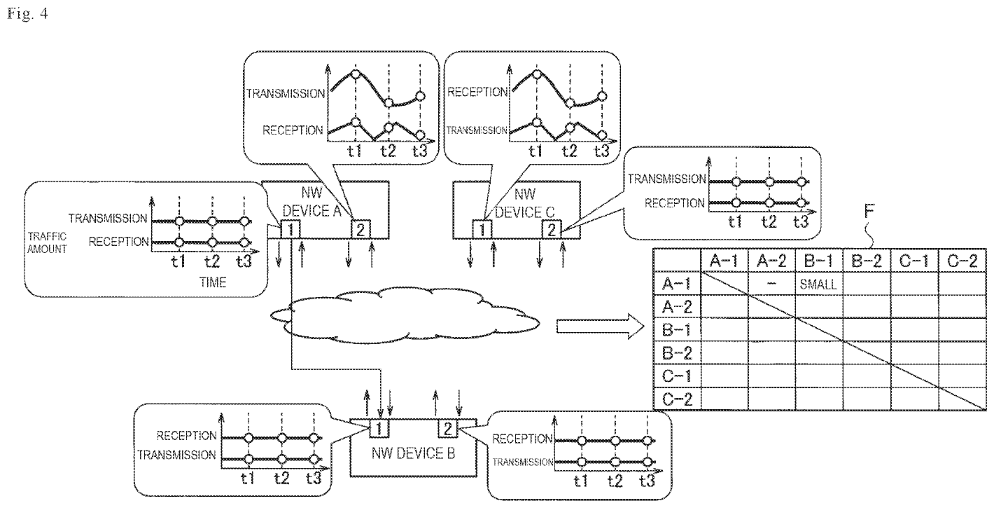

For example, as illustrated in FIG. 4, when an IF of a NW device A is defined as A-1 and an IF of a NW device B is defined as B-1, a difference value between a received traffic amount of A-1 and a transmitted traffic amount of B-1 is calculated. Similarly, a difference value between a received traffic amount of B-1 and a transmitted traffic amount of A-1 is calculated. The magnitude of a difference between the two difference values is then determined, and a difference value calculation table F is filled in with “small” (=IF connection relation: high) in a case where the difference is small and filled in with “large” (=IF connection relation: low) in a case where the difference is large. Meanwhile, in FIG. 4, for the purpose of simplification, the number of NW devices is set to three, and the number of IFs of each NW device is set to two. In addition, it is a condition that the IFs of the same NW device are not connected to each other.

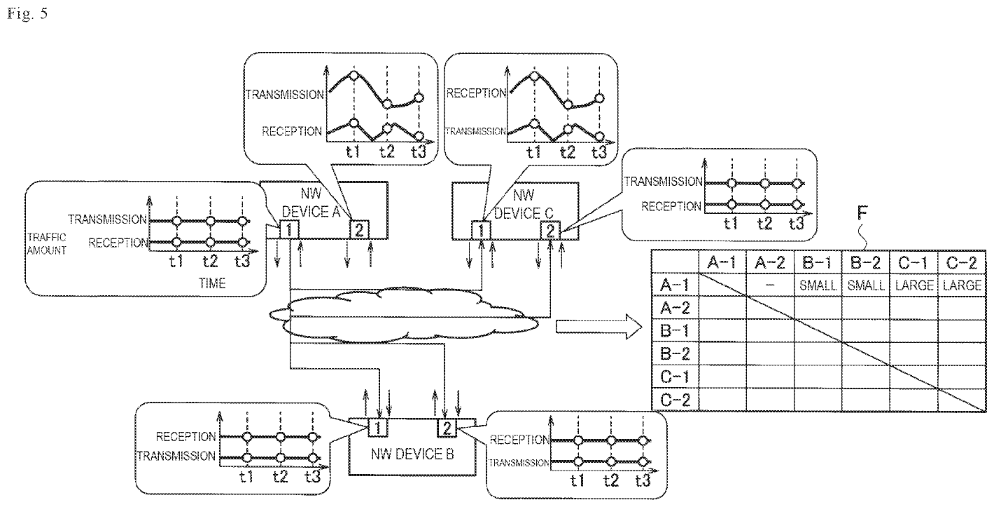

Next, the setting unit 133 similarly obtains each difference between the IFᵢ and the remaining IFs (B-2, C-1, and C-2), and sets the determination result of each difference in the difference value calculation table F (step S3-2). All the setting results so far are as shown in the difference value calculation table F illustrated in FIG. 5.

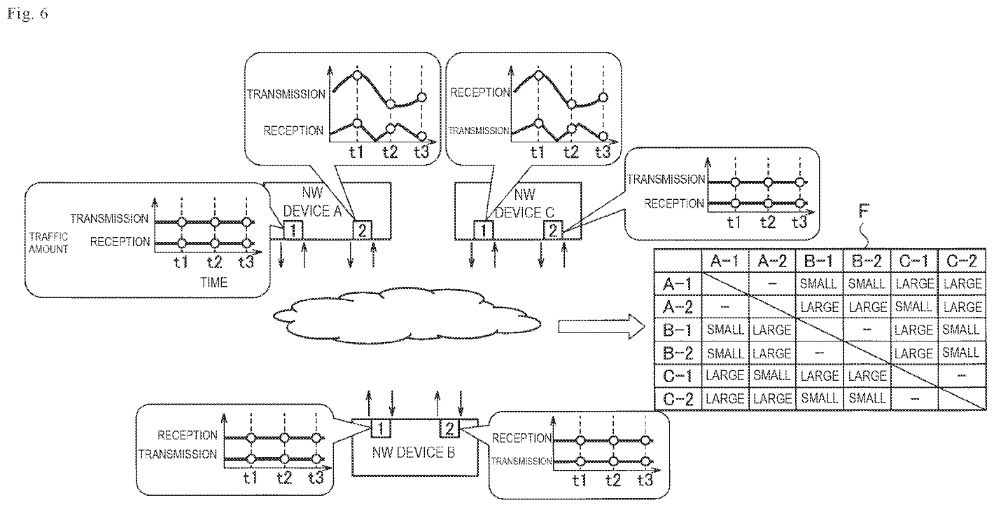

Thereafter, the setting unit 133 similarly obtains each difference between the IFs of all the NW devices that are targets for topology estimation and sets the determination result of each difference in the difference value calculation table F (step S3-3). All the setting results are as shown in the difference value calculation table F illustrated in FIG. 6. For traffic amounts flowing in the IFs, as the number of similar traffic amounts becomes larger, the number of IFs between which the difference is “small” increases.

Step S4;

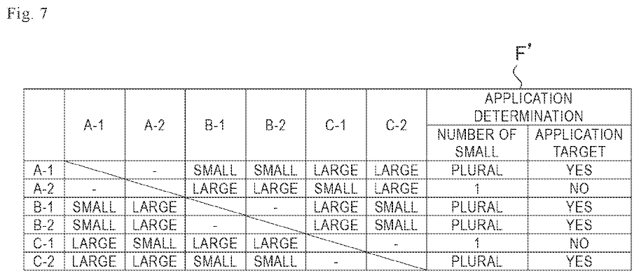

Next, the determination unit 134 determines whether the IF connection relation is set to be “high” with a plurality of other IFs in each IF using the setting result of the IF connection relation in each IF of each NW device. For example, the determination unit 134 calculates the number of “small” (=IF connection relation: high) setting values set in each IF from the difference value calculation table F and determines whether the number of “small” setting values is plural. For example, the determination unit 134 generates an application target IF determination table F′ as illustrated in FIG. 7. For IF of which the determination result is YES, step S5 and the subsequent processing operations are performed. On the other hand, IF of which the determination result is NO, that is, IF in which the IF connection relation is set to be “high” with only one other IF (=IF in which the number of “small” setting values is one in the difference value calculation table F), is determined to be IF that is target for traffic non-application, and the processing is ended.

Step S5;

The determination unit 134 determines IF in which the IF connection relation is set to be “high” with a plurality of other IFs (=IF in which the number of “small” setting values is plural in the difference value calculation table F) to be IF that is a target for traffic application, and inputs IF information of the IF that is a target for traffic application to the distribution unit 136.

Step S6;

Next, the arithmetic operation unit 135 refers to the IF information of the IF that is a target for traffic application which is input to the distribution unit 136 and uses the traffic data (transmitted and received traffic amount) acquired in step S1 to calculate the time variation of the traffic amount for the IF that is a target for traffic application.

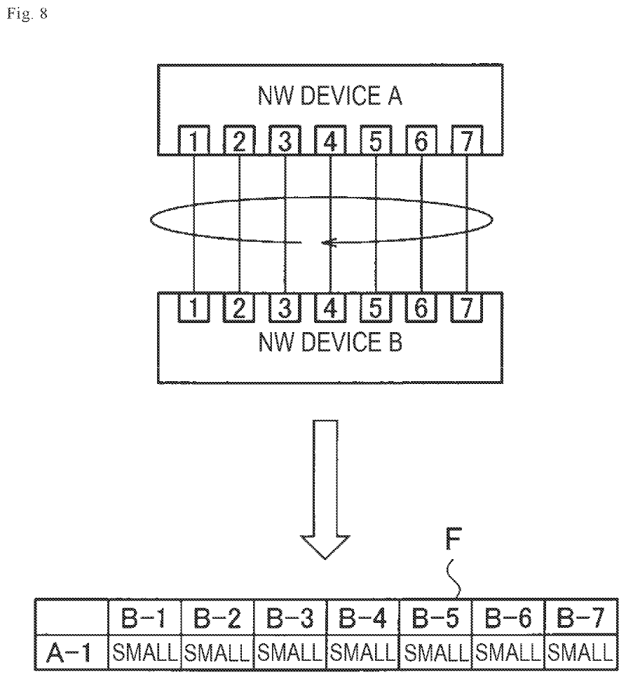

Here, the reason for calculating the time variation of the traffic amount will be described. Normally, in a case where a load balancer is interposed between two NW devices or in a case where an LAG configuration is constituted of two NW devices, the values of traffic amounts which are acquired by a plurality of IFs are likely to be close to each other. Thus, for example, in the case of the LAG configuration as illustrated in FIG. 8, all differences between A-1 of the NW device A and seven B-1 to B-7 of the NW device B are small, and all the IF connection relations are set to be “high” (=all seven setting values in the difference value calculation table F are “small”). In this case, the A-1 is determined to be an IF that is a target for traffic application.

However, for each IF having a load balancer or an LAG configuration, the average traffic amount is approximately constant for each IF, but each IF can be sufficiently identified by taking a difference value of traffic data between the IFs at each time. That is, such an IF can be estimated with sufficient accuracy even though the traffic data before the application of the test traffic is used, and thus does not necessarily need to be included in an IF that is a target for traffic application.

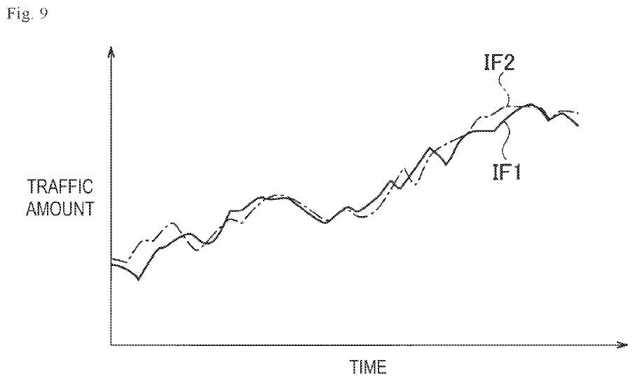

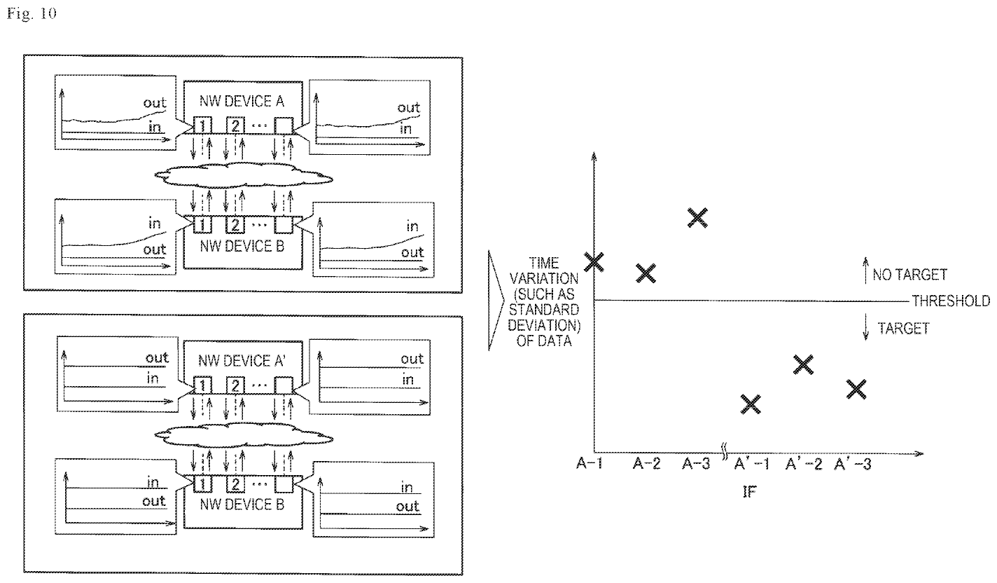

Consequently, in order to avoid such a situation, not only the difference in traffic amount, but also another index is used. Specifically, the time variation (for example, standard deviation) of the traffic amount in each IF is used. A graph illustrated in FIG. 9 illustrates an example of time variation of each traffic amount of an IF 1 and an IF 2 which are an LAG configuration. In the LAG configuration, the average traffic amount is approximately constant in each IF, but when data at each time is viewed, sufficient identification can be performed when a difference value is taken. Thus, as illustrated in FIG. 10, IF in which the time variation of the traffic amount is large is excluded from IFs that are targets for traffic application, and only IF in which the time variation of the traffic amount is small is defined as IF that is a target for traffic application. Thereby, IFs having a load balancer or an LAG configuration are excluded from the IFs that are targets for traffic application.

Consequently, next, the arithmetic operation unit 135 determines whether the time variation of the traffic amount of the IFs that are targets for traffic application determined in step S5 is less than or equal to a threshold. For example, the arithmetic operation unit 135 provides a threshold, for example, with a standard deviation, determines IF in which the time variation of the traffic amount is less than or equal to the threshold, among the IFs that are targets for traffic application determined in step S5, as IF that is a target for traffic application, and performs step S8 and the subsequent processing operations. On the other hand, a determination is made to exclude the IF in which the time variation of the traffic amount exceeds the threshold from the IFs that are targets for traffic application, and the processing is ended. Meanwhile, as for how to determine a threshold, a method of statically setting a value based on the empirical rule of operation or the like can be considered.

Step S8;

The arithmetic operation unit 135 inputs the IF information of the IF that is a target for traffic application determined in step S7 to the distribution unit 136. Thereby, the IF information which is input to the distribution unit 136 in step S5 is updated.

Step S9;

Next, the distribution unit 136 distributes an IF included in the IF information updated in step S8 to the IF that is a target for traffic application to which the test traffic is to be applied. Thereafter, the transmission unit 138 transmits the IF information of the IF distributed to the IF that is a target for traffic application, to which the test traffic is to be applied, to the traffic application device 14.

Step S10;

Finally, the third storage unit 137 stores IF information of the IF distributed to the IF that is a target for traffic application to which the test traffic is to be applied.

Effect

According to the present embodiment, the traffic application IF determination device 13 can provide a technique capable of appropriately and efficiently determining an IF to which test traffic is to be applied by including a setting unit 133 that performs processing of, in two different IFs, setting an IF connection relation between the two IFs to be high in a case where a difference between a difference value between a traffic amount received by one IF and a traffic amount transmitted by another IF and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in the same NW device, and a determination unit 134 that performs processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

In addition, according to the present embodiment, it is possible to provide a technique capable of more appropriately and efficiently determining an IF to which test traffic is to be applied by including an arithmetic operation unit 135 that excludes, in a case where time variation of a traffic amount in the IF that is a target for traffic application exceeds a threshold, the IF that is a target for traffic application from IFs that are targets for traffic application.

Others

Meanwhile, the present disclosure is not limited to the above embodiment and can be modified and changed variously without departing from the scope of the present disclosure.

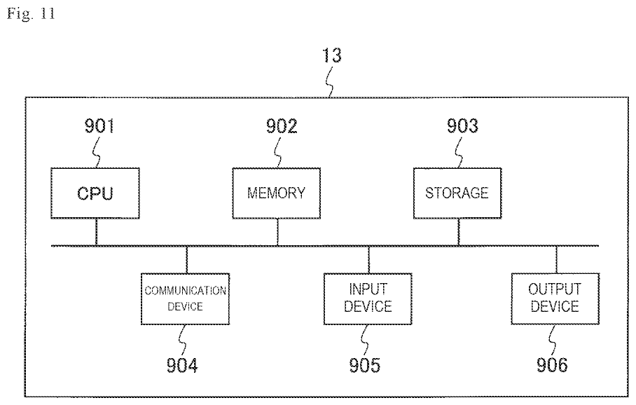

In addition, as illustrated in FIG. 11, the traffic application IF determination device 13 according to the present embodiment can use a general-purpose computer system including, for example, a CPU 901, a memory 902, a storage 903 such as a hard disk drive (HDD) or a solid state drive (SSD), a communication device 904, an input device 905, and an output device 906. The memory 902 and the storage 903 are storage devices. In the computer system, each function of the traffic application IF determination device 13 is implemented by the CPU 901 executing a predetermined program loaded on the memory 902.

Meanwhile, the traffic application IF determination device 13 may be implemented in one computer or may be implemented in a plurality of computers. In addition, the traffic application IF determination device 13 may be a virtual machine which is implemented in a computer. A program for the traffic application IF determination device 13 can be stored in a computer readable recording medium such as an HDD, an SSD, a universal serial bus (USB) memory, a compact disc (CD), or a digital versatile disc (DVD) or can be delivered through a network.

### REFERENCE SIGNS LIST

1 Topology estimation system
11 Traffic collection device
12 Topology estimation device
13 Traffic application IF determination device
14 Traffic application device
131 First storage unit
132 Second storage unit
133 Setting unit
134 Determination unit
135 Arithmetic operation unit
136 Distribution unit
137 Third storage unit
138 Transmission unit
901 CPU
902 Memory
903 Storage
904 Communication device
905 Input device
906 Output device

1. A traffic application IF determination device comprising:
a setting unit, including one or more processors, configured to perform processing of, in two IFs that are different, setting an IF connection relation between the two IFs to be high in a case where a difference between a difference value between a traffic amount received by one IF of the two IFs and a traffic amount transmitted by another IF of the two IFs and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in an identical NW device; and
a determination unit, including one or more processors, configured to perform processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

2. The traffic application IF determination device according to claim 1, further comprising an arithmetic operation unit, including one or more processors, configured to exclude, in a case where time variation of a traffic amount in the IF that is a target for traffic application exceeds a threshold, the IF that is a target for traffic application from a plurality of the IFs that are targets for traffic application.

3. A traffic application IF determination method that is performed by a traffic application IF determination device, the method comprising:
performing, by the traffic application IF determination device, processing of, in two IFs that are different, setting an IF connection relation between the two IFs to be high in a case where a difference between a difference value between a traffic amount received by one IF of the two IFs and a traffic amount transmitted by another IF of the two IFs and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in an identical NW device; and
performing, by the traffic application IF determination device, processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

4. A non-transitory computer-readable storage medium storing a traffic application IF determination program causing a computer to operate as a traffic application IF determination device to perform a traffic application IF determination method comprising:
performing, by the traffic application IF determination device, processing of, in two IFs that are different, setting an IF connection relation between the two IFs to be high in a case where a difference between a difference value between a traffic amount received by one IF of the two IFs and a traffic amount transmitted by another IF of the two IFs and a difference value between a traffic amount received by the other IF and a traffic amount transmitted by the one IF is small and setting the IF connection relation between the two IFs to be low in a case where the difference is large for a plurality of IFs included in a plurality of different NW devices, excluding between a plurality of IFs included in an identical NW device; and
performing, by the traffic application IF determination device, processing of, in a predetermined IF, determining the predetermined IF to be an IF that is a target for traffic application in a case where the IF connection relation is set to be high with a plurality of other IFs and determining the predetermined IF to be an IF that is a target for traffic non-application in a case where the IF connection relation is set to be high with only one other IF for the plurality of IFs.

5. The non-transitory computer-readable storage medium according to claim 4, wherein the traffic application IF determination method further comprises:
excluding, in a case where time variation of a traffic amount in the IF that is a target for traffic application exceeds a threshold, the IF that is a target for traffic application from a plurality of the IFs that are targets for traffic application.

6. The traffic application IF determination method according to claim 3, further comprising:
excluding, in a case where time variation of a traffic amount in the IF that is a target for traffic application exceeds a threshold, the IF that is a target for traffic application from a plurality of the IFs that are targets for traffic application.
